(19) United States
(12) Patent Application Publication
(10) Pub. No.: US 2020/0410479 A1
(43) Pub. Date: Dec. 31, 2020

(54) METHOD AND SYSTEM FOR BLOCKCHAIN TRUST MANAGEMENT TO AVOID ONLINE FRAUD

(71) Applicant: Synchronoss Technologies, Inc., Bridgewater, NJ (US)

(72) Inventors: Luis Campo Giralte, Dublin (IE); Gian Luigi Romita, Limerick (IE)

(21) Appl. No.: 16/454,332

(22) Filed: Jun. 27, 2019

(51) Int. Cl. G06Q 20/36; H04L 9/06; H04L 9/32; G06Q 20/40; G06Q 20/38; G06F 17/27

(52) U.S. Cl. CPC G06Q 20/3678; H04L 9/0637; G06F 17/2785; G06Q 20/4016; G06Q 20/383; H04L 9/3297

(57) ABSTRACT

A computer implemented method and apparatus for optimized online presence blockchain trust management to avoid online fraud. The method comprises receiving a first email message from a mail server, wherein the first message is from a seller to a buyer confirming an online transaction; receiving a second email message from the mail server, wherein the second email message is from a payment service to the buyer confirming a payment for an online transaction; extracting information from the first email message and the second email message; correlating the first email message and the second email message when the first email message and the second email message references a same online transaction; anonymizing personal information of a buyer that was extracted from the first email message and the second email message; generating a block of data related to the transaction from the extracted information regarding the online transaction and the anonymized information of the buyer; encrypting the generated block of data related to the transaction; and publishing the encrypted block of data to a blockchain.

### BACKGROUND OF THE INVENTION

### Field of the Invention

Embodiments of the present invention generally relate to online fraud, and more specifically to a method and system for blockchain trust management to avoid online fraud.

### Description of the Related Art

Consumers have gotten used to doing business online. They may purchase merchandise and services from a trustworthy entity. Typically, the consumer has an account registered with the entity and provides the entity sensitive information. The risk of doing business online is low, as long as you deal directly with organizations you trust. Unfortunately, fraud in e-commerce comes in several different forms, such as unauthorized purchases, identity theft, and the like. For example, phishing involves a crook disguising him or herself as a trustworthy entity in order to obtain sensitive information about an electronic consumer, such as usernames, passwords, and credit card details. The consumer may receive an email that appears to be from, for example your bank but is actually part of a phishing scam. When the consumer clicks on a login link and provides their username, password, or PIN, the crook obtains your sensitive information, credit card details, PINs, and the like and uses the information to steal the consumer's money or use the credit card information to make purchases.

Therefore, there is a need for blockchain trust management to avoid online fraud.

### SUMMARY OF THE INVENTION

An apparatus and/or method is provided for blockchain trust management to avoid online fraud substantially as shown in and/or described in connection with at least one of the figures.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 depicts a block diagram of a system for blockchain trust management to avoid online fraud, according to one or more embodiments of the invention;

FIG. 2 depicts a flow diagram of a method for blockchain trust management to avoid online fraud, according to one or more embodiments of the invention; and

FIG. 3 depicts a computer system that can be utilized in various embodiments of the present invention to implement the computer and/or the display, according to one or more embodiments of the invention.

While the method and apparatus is described herein by way of example for several embodiments and illustrative drawings, those skilled in the art will recognize that the method and apparatus for blockchain trust management to avoid online fraud is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and apparatus for blockchain trust management to avoid online fraud defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

Techniques are disclosed for a system and method for blockchain trust management to avoid online fraud, according to embodiments of the invention. An online buyer has previously registered with an e-commerce site, for example Amazon®. The buyer has also previously registered with their preferred payment method, such as PayPal® or a bank or credit card. When the buyer makes a purchase, for example on Amazon® using their PayPal® account, a first email message is sent from Amazon® to the user confirming the purchase and a second email message is sent from PayPal® confirming their payment. A mail service provider (MSP) verifies the email messages using standard authentication methods. The MSP then forwards the first and second email messages to the anti-fraud system where a natural language processing unit (NLPU) extracts relevant information about the transaction from each email message. A correlation engine correlates email messages that are for a same online transaction by determining for example a same purchase price, reference number, timeframe in which the purchase and payment transaction occurred, possibly the item purchased if it is mentioned in both email messages. For example, the NLPU may extract from the first email message from Amazon® a reference number 12345, with a transaction occurring at 12:01 pm on Jun. 1, 2019, for a bottle of perfume at a purchase price of $125.00. The NLPU may extract from the second email message from PayPal® a reference number 12345, with a transaction occurring at 12:04 pm on Jun. 1, 2019 in the amount of $125.00. The correlation engine recognizes similar information in both email messages and correlates the first email message and the second email message, thereby determining that they are for the same transaction. The buyer's private information from the email messages (e.g., name, home address, etc.) is anonymized. A signature is generated for the transaction data using, for example the DomainKeys Identified Mail (DKIM) private key of the MSP. The generated block of transaction data is published into a public blockchain. Once the block is written on the block chain, it becomes public and anyone may verify the information on the blockchain using the public key of the MSP.

Various embodiments of a method and apparatus for blockchain trust management to avoid online fraud are described. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description that follow are presented in terms of algorithms or symbolic representations of operations on binary digital signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

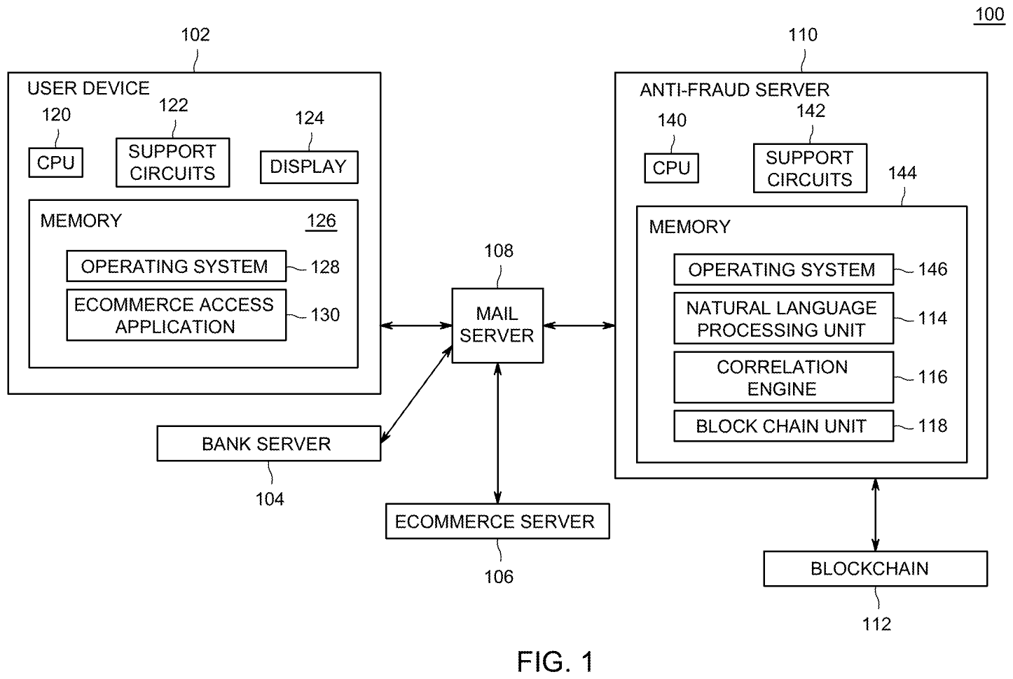

FIG. 1 depicts a block diagram of a system 100 for blockchain trust management to avoid online fraud, according to one or more embodiments of the invention. The system 100 includes a user device 102, a bank server 104 (i.e. any institution associated with a method of payment), an ecommerce server 106, a mail server 108, an anti-fraud server 110, and a block chain 112.

The user device 102 is a computing device, for example a desktop computer, laptop, tablet computer, and the like. The user device 102 includes a Central Processing Unit (CPU) 120, support circuits 122, a display 124, and a memory 126. The CPU 120 may include one or more commercially available microprocessors or microcontrollers that facilitate data processing and storage. The various support circuits 122 facilitate the operation of the CPU 120 and include one or more clock circuits, power supplies, cache, input/output circuits, and the like. The memory 126 includes at least one of Read Only Memory (ROM), Random Access Memory (RAM), disk drive storage, optical storage, removable storage and/or the like. The memory 126 includes an operating system 128 and an ecommerce access application 130. The operating system 128 may include various commercially known operating systems. The ecommerce access application 130 is used to access the ecommerce server 106. In some embodiments, the ecommerce access application 130 is a mobile application on the user device 102 downloaded from an app store (not shown). In some embodiments, the ecommerce access application 130 is an online store accessed by the user device 102 via a browser (not shown).

The banking server 104 may be any payment service that secures payments by a pre-registered user, such as a credit card, a bank transfer, or a payment service such as PayPal®, and the like. The ecommerce server 106 similarly provides secure purchases by a pre-registered user. The banking server 104 and the ecommerce server 106 send verification email messages to the user via the mail server 108.

The anti-fraud server 110 is a computing device, for example a desktop computer, laptop, tablet computer, and the like or the anti-fraud server 110 may be a cloud based server e.g., a blade server, virtual machine, and the like. includes a Central Processing Unit (CPU) 140, support circuits 142, and a memory 144. The CPU 140 may include one or more commercially available microprocessors or microcontrollers that facilitate data processing and storage. The various support circuits 142 facilitate the operation of the CPU 140 and include one or more clock circuits, power supplies, cache, input/output circuits, and the like. The memory 144 includes at least one of Read Only Memory (ROM), Random Access Memory (RAM), disk drive storage, optical storage, removable storage and/or the like. The memory 144 includes an operating system 146, a natural language processing unit (NLPU) 114, a correlation engine 116, and a block chain unit (BCU) 118.

A buyer on user device 102 registers with a bank or other payment service. A mail transfer agent (MTA) receives the email message for the registration on the banking server 104 and verifies that the message is valid using standard email authentication methods such as DomainKeys Identified Mail (DKIM) or Domain Message Authentication Reporting and Conformance (DMARC). The MTA forwards the email message to the anti-fraud server 110. The NLPU 114 recognizes that the user has been registered on the banking server 104 and keeps track of the information for future transactions (i.e., the NLPU understands the paying method of the buyer). The buyer on user device 102 also registers on an ecommerce server 106, such as Amazon®. Similarly, an MTA receives the email message for registration on the ecommerce server 106 and verifies that the email message is valid using for example, DKIM or DMARC. The email message is forwarded to the anti-fraud server 110. The NLPU 114 now recognizes the ecommerce server, for example Amazon® as a “seller”.

A buyer on user device 102 uses the ecommerce access application 130 to access the ecommerce server 106 to make a purchase. The buyer uses their information associated with banking server 104 to pay for the purchase. When the purchase process is completed the ecommerce server 106 sends a confirmation email message to the user via mail server 108. Similarly, the banking server 104 sends a confirmation email message to the user via mail server 108. The mail server 108 forwards the email messages to the anti-fraud server 110. The NLPU 114 verifies that the message is an online transaction and extracts the relevant information regarding the transaction, such as a seller, buyer's email address, date, purchase amount, description, and the like.

The block chain unit (BCU) 118 anonymizes the buyer's personal information extracted from the email message, such as the buyer's name, home address, and the like. When the transaction information has been anonymized, the BCU uses the private key of the mail server 108 to generate a signature with the transaction data, thereby encrypting the transaction data. The BCU then uses an Application Programming Interface (API) for publishing the generated transaction data block into the public blockchain 112. Once the block is written on the block chain, it becomes public and the information may be verified using the DKIM public key of the mail server 108.

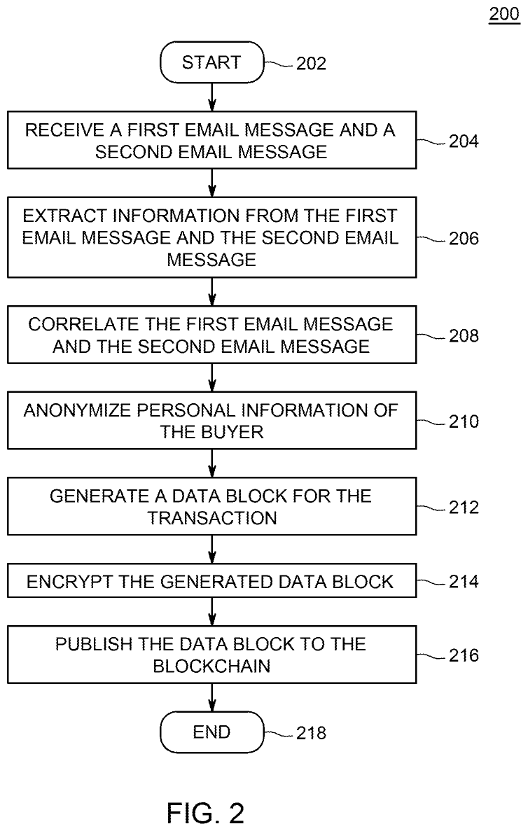

FIG. 2 depicts a flow diagram of a method 200 for blockchain trust management to avoid online fraud, according to one or more embodiments of the invention. Prior to the initiation of method 200, a buyer has executed an online transaction. As an example, a buyer has purchased a clock from a seller (e.g., Amazon®) using a payment service or bank (e.g., PayPal® account) for payment. The method starts at step 202 and proceeds to step 204.

At step 204, a first email message and a second email message are received from a mail server. A first email message may be a confirmation email message from the seller confirming the purchase of the clock. The first email message may include transaction information for example, an order reference number, a time the transaction was completed, a buyer's name and home address, an order total purchase amount, and a delivery date. A second email message may be a confirmation email message from the bank confirming payment details for the clock. The second email message may include transaction information for example, an order reference number, a seller, a time the bank transaction was completed, and an amount paid.

At step 206, transaction information is extracted from the first email message and the second email message using natural language recognition techniques.

At step 208, the messages are correlated. A significant number of email messages are received and the information extracted from each. Correlating messages involves determining which email messages relate to a same transaction. In other words, it is determined whether the first email message and the second email message include for example, a same seller, a same purchase amount, a same buyer, and the transactions occurred within a same timeframe. If the information extracted from each email message is sufficient to determine that the email messages reference the same online purchase, then the email messages are considered to be correlated.

At step 210, the personal information of the buyer is anonymized, such as the name, address, and email of the buyer.

At step 212, a data block for the transaction is generated. The data block includes relevant information about the transaction, such as the seller, the anonymized email of the buyer, the date of the transaction, the amount of the transaction, a description of the item purchase, and the like.

At step 214, the data block for the transaction is encrypted. Using a private key of the mail server, a digital signature is generated for the data block. The digital signature enables the data block to be validated when the data block is sent to the blockchain.

At step 216, the encrypted data block is published to the blockchain. Using a generic Application Programming Interface (API), the encrypted data block is published to the blockchain. Once the block is written to the block chain it becomes public and anyone may verify the information using the public key of the mail server.

The method ends at step 218.

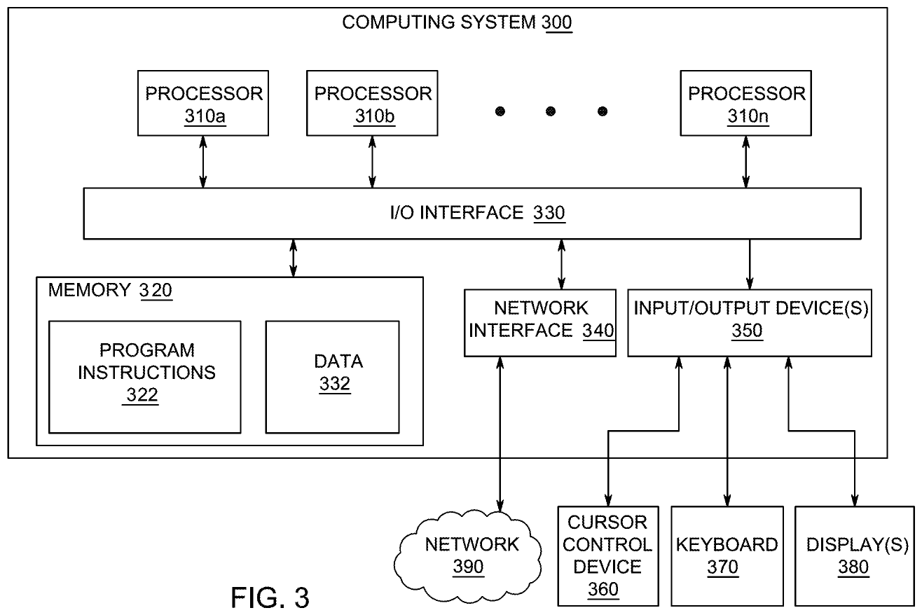

FIG. 3 depicts a computer system that can be used to implement the method of FIG. 2 in various embodiments of the present invention, according to one or more embodiments of the invention.

Various embodiments of method and apparatus for blockchain trust management to avoid online fraud, as described herein, may be executed on one or more computer systems, which may interact with various other devices. One such computer system is computer system 300 illustrated by FIG. 3, which may in various embodiments implement any of the elements or functionality illustrated in FIGS. 1-2. In various embodiments, computer system 300 may be configured to implement methods described above. The computer system 300 may be used to implement any other system, device, element, functionality or method of the above-described embodiments. In the illustrated embodiments, computer system 300 may be configured to implement method 200, as processor-executable executable program instructions 322 (e.g., program instructions executable by processor(s) 310) in various embodiments.

In the illustrated embodiment, computer system 300 includes one or more processors 310 coupled to a system memory 320 via an input/output (I/O) interface 330. Computer system 300 further includes a network interface 340 coupled to I/O interface 330, and one or more input/output devices 350, such as cursor control device 360, keyboard 370, and display(s) 380. In various embodiments, any of components may be utilized by the system to receive user input described above. In various embodiments, a user interface may be generated and displayed on display 380. In some cases, it is contemplated that embodiments may be implemented using a single instance of computer system 300, while in other embodiments multiple such systems, or multiple nodes making up computer system 300, may be configured to host different portions or instances of various embodiments. For example, in one embodiment some elements may be implemented via one or more nodes of computer system 300 that are distinct from those nodes implementing other elements. In another example, multiple nodes may implement computer system 300 in a distributed manner.

In different embodiments, computer system 300 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 300 may be a uniprocessor system including one processor 310, or a multiprocessor system including several processors 310 (e.g., two, four, eight, or another suitable number). Processors 310 may be any suitable processor capable of executing instructions. For example, in various embodiments processors 310 may be general-purpose or embedded processors implementing any of a variety of instruction set architectures (ISAs), such as the x96, PowerPC, SPARC, or MIPS ISAs, or any other suitable ISA. In multiprocessor systems, each of processors 310 may commonly, but not necessarily, implement the same ISA.

System memory 320 may be configured to store program instructions 322 and/or data 332 accessible by processor 310. In various embodiments, system memory 320 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 320. In other embodiments, program instructions and/or data may be received, sent or stored upon different types of computer-accessible media or on similar media separate from system memory 320 or computer system 300.

In one embodiment, I/O interface 330 may be configured to coordinate I/O traffic between processor 310, system memory 320, and any peripheral devices in the device, including network interface 340 or other peripheral interfaces, such as input/output devices 350. In some embodiments, I/O interface 330 may perform any necessary protocol, timing or other data transformations to convert data signals from one components (e.g., system memory 320) into a format suitable for use by another component (e.g., processor 310). In some embodiments, I/O interface 330 may include support for devices attached through various types of peripheral buses, such as a variant of the Peripheral Component Interconnect (PCI) bus standard or the Universal Serial Bus (USB) standard, for example. In some embodiments, the function of I/O interface 330 may be split into two or more separate components, such as a north bridge and a south bridge, for example. Also, in some embodiments some or all of the functionality of I/O interface 330, such as an interface to system memory 320, may be incorporated directly into processor 310.

Network interface 340 may be configured to allow data to be exchanged between computer system 300 and other devices attached to a network (e.g., network 390), such as one or more external systems or between nodes of computer system 300. In various embodiments, network 390 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 340 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 350 may, in some embodiments, include one or more display terminals, keyboards, keypads, touch pads, scanning devices, voice or optical recognition devices, or any other devices suitable for entering or accessing data by one or more computer systems 300. Multiple input/output devices 350 may be present in computer system 300 or may be distributed on various nodes of computer system 300. In some embodiments, similar input/output devices may be separate from computer system 300 and may interact with one or more nodes of computer system 300 through a wired or wireless connection, such as over network interface 340.

In some embodiments, the illustrated computer system may implement any of the methods described above, such as the methods illustrated by the flowchart of FIG. 2. In other embodiments, different elements and data may be included.

Those skilled in the art will appreciate that computer system 300 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, etc. Computer system 300 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 300 may be transmitted to computer system 300 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, etc.), ROM, etc.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer implemented method for blockchain trust management to avoid online fraud, comprising:
receiving a first email message from a mail server, wherein the first message is from a seller to a buyer confirming an online transaction;
receiving a second email message from the mail server, wherein the second email message is from a payment service to the buyer confirming a payment for an online transaction;
extracting information from the first email message and the second email message;
correlating the first email message and the second email message when the first email message and the second email message reference a same online transaction;
anonymizing personal information of a buyer that was extracted from the first email message and the second email message;
generating a block of data related to the transaction from the extracted information regarding the online transaction and the anonymized information of the buyer;
encrypting the generated block of data related to the transaction; and
publishing the encrypted block of data to a blockchain.

2. The method of claim 1, wherein the information is extracted using natural language recognition techniques.

3. The method of claim 1, wherein the extracted information includes at least the buyer, the seller, a purchase amount for the transaction, a timestamp of the purchase from the first email message, and a timestamp of the payment from the second email message.

4. The method of claim 3, wherein correlating comprises determining the first email message and the second email message reference a same seller, a same buyer, a same purchase amount, and the timestamp of the purchase and the timestamp of the payment are within a predefined timespan.

5. The method of claim 1, wherein the personal information of the buyer includes at least a name of the buyer, an address of the buyer, and an email address of the buyer.

6. The method of claim 1, wherein the generated block of data includes at least the seller, the anonymized email address of the buyer, a date of the transaction, and a purchase amount for the transaction.

7. The method of claim 1, wherein encrypting the generated block of data comprises digitally signing the block of data with a private key of the mail server.

8. A system for blockchain trust management to avoid online fraud, comprising:
a) at least one processor;
b) at least one input device; and
c) at least one storage device storing processor-executable instructions which, when executed by the at least one processor, perform a method including:
receiving a first email message from a mail server, wherein the first message is from a seller to a buyer confirming an online transaction;
receiving a second email message from the mail server, wherein the second email message is from a payment service to the buyer confirming a payment for an online transaction;
extracting information from the first email message and the second email message;
correlating the first email message and the second email message when the first email message and the second email message reference a same online transaction;
anonymizing personal information of a buyer that was extracted from the first email message and the second email message;
generating a block of data related to the transaction from the extracted information regarding the online transaction and the anonymized information of the buyer;
encrypting the generated block of data related to the transaction; and
publishing the encrypted block of data to a blockchain.

9. The system of claim 8, wherein the information is extracted using natural language recognition techniques.

10. The system of claim 8, wherein the extracted information includes at least the buyer, the seller, a purchase amount for the transaction, a timestamp of the purchase from the first email message, and a timestamp of the payment from the second email message.

11. The system of claim 10, wherein correlating comprises determining the first email message and the second email message reference a same seller, a same buyer, a same purchase amount, and the timestamp of the purchase and the timestamp of the payment are within a predefined timespan.

12. The system of claim 8, wherein the personal information of the buyer includes at least a name of the buyer, an address of the buyer, and an email address of the buyer.

13. The system of claim 8, wherein the generated block of data includes at least the seller, the anonymized email address of the buyer, a date of the transaction, and a purchase amount for the transaction.

14. The system of claim 8, wherein encrypting the generated block of data comprises digitally signing the block of data with a private key of the mail server.

15. A non-transitory computer readable medium for storing computer instructions that, when executed by at least one processor causes the at least one processor to perform a method for blockchain trust management to avoid online fraud, comprising:
receiving a first email message from a mail server, wherein the first message is from a seller to a buyer confirming an online transaction;
receiving a second email message from the mail server, wherein the second email message is from a payment service to the buyer confirming a payment for an online transaction;
extracting information from the first email message and the second email message;
correlating the first email message and the second email message when the first email message and the second email message reference a same online transaction;
anonymizing personal information of a buyer that was extracted from the first email message and the second email message;
generating a block of data related to the transaction from the extracted information regarding the online transaction and the anonymized information of the buyer;
encrypting the generated block of data related to the transaction; and
publishing the encrypted block of data to a blockchain.

16. The non-transitory computer readable medium of claim 15, wherein the information is extracted using natural language recognition techniques.

17. The non-transitory computer readable medium of claim 15, wherein the extracted information includes at least the buyer, the seller, a purchase amount for the transaction, a timestamp of the purchase from the first email message, and a timestamp of the payment from the second email message.

18. The non-transitory computer readable medium of claim 17, wherein correlating comprises determining the first email message and the second email message reference a same seller, a same buyer, a same purchase amount, and the timestamp of the purchase and the timestamp of the payment are within a predefined timespan.

19. The non-transitory computer readable medium of claim 15, wherein the personal information of the buyer includes at least a name of the buyer, an address of the buyer, and an email address of the buyer.

20. The non-transitory computer readable medium of claim 15, wherein the generated block of data includes at least the seller, the anonymized email address of the buyer, a date of the transaction, and a purchase amount for the transaction, and wherein encrypting the generated block of data comprises digitally signing the block of data with a private key of the mail server.
